(19) United States
(12) Patent Application Publication
(10) Pub. No.: US 2026/0212777 A1
(43) Pub. Date: Jul. 23, 2026

(54) SYSTEMS AND METHODS FOR AN ADAPTIVE AI-DRIVEN INTERACTIVE EDUCATIONAL PLATFORM WITH INTEGRATED ASSESSMENTS

(71) Applicant: Sadie R. Gunnink, Rice Lake, WI (US)

(72) Inventor: Sadie R. Gunnink, Rice Lake, WI (US)

(21) Appl. No.: 19/452,555

(22) Filed: Jan. 19, 2026

Related U.S. Application Data
(60) Provisional application No. 63/747,967, filed on Jan. 22, 2025.

(51) Int. Cl. G09B 7/00

(52) U.S. Cl. CPC G09B 7/00

(57) ABSTRACT

An adaptive digital game-based learning system and method are disclosed. The system presents an interactive game-based environment configured to deliver instructional content aligned with one or more standardized academic curricula. Assessment data is collected from both gameplay-based interactions and explicit instructional assessments. The system analyzes the assessment data to infer an instructional proficiency level of a learner relative to academic standards and updates a learner profile accordingly. Instructional content delivery within the interactive game-based environment is dynamically adapted based on the inferred instructional proficiency level. The system may further utilize psychometric data associated with the learner to inform presentation, pacing, or sequencing of instructional content while maintaining curriculum alignment. The disclosed system supports continuous evaluation of learner progress and adaptive instructional delivery within a unified game-based learning platform.

### CROSS REFERENCE TO RELATED APPLICATIONS

This application claims the benefit of U.S. Provisional Ser. No. 63/747,967, filed Jan. 22, 2025, and entitled “Systems and Methods for an Adaptive AI-Driven Interactive Educational Platform with Integrated Assessments,” the entirety of which is incorporated herein by reference.

### TECHNICAL FIELD

The present disclosure relates generally to computer-implemented educational systems and methods, and more particularly to adaptive digital game-based learning software that delivers standardized academic curriculum and assesses learner instructional proficiency through interactive gameplay and instructional assessments.

### BACKGROUND

Learning is a process through which individuals acquire knowledge, skills, and competencies across a range of academic subjects. Traditional instructional models often rely on periodic testing or discrete instructional activities to evaluate learner proficiency, which may provide limited insight into a learner's evolving instructional level over time.

Various digital learning platforms have been developed to deliver educational content using interactive or game-like elements. While such platforms may increase learner engagement, many rely on explicit assessments that interrupt instructional flow or treat educational content as separate from gameplay mechanics. In other systems, game-based elements serve primarily as incentives or rewards rather than as integral components of instructional delivery and assessment.

Additionally, existing educational gaming systems frequently focus on isolated subject areas or predefined skill objectives, limiting their ability to assess learner proficiency across multiple standardized academic domains or to dynamically adjust instructional content based on a learner's inferred instructional grade level.

Accordingly, there exists a need for an educational software system that integrates instructional delivery and assessment within an interactive game-based environment, enables both implicit and explicit assessment of learner proficiency, and dynamically adapts standardized curriculum content based on continuously inferred instructional skill levels.

### SUMMARY OF THE INVENTION

The present disclosure provides a computer-implemented adaptive digital game-based learning system configured to infer and continuously update a learner's instructional grade-level across one or more standardized academic subjects. The system integrates instructional content delivery and assessment within an interactive game-based environment, enabling learners to progress through academic material while engaging in gameplay.

In one or more embodiments, the system generates assessment data from a combination of gameplay-based interactions and explicit instructional assessments. Gameplay-based interactions may include learner actions, decision-making patterns, task completion metrics, and other in-game behaviors that implicitly reflect instructional proficiency. Explicit instructional assessments may include quizzes, placement tests, mastery checkpoints, or other evaluative instruments presented within or alongside the game-based environment.

The system processes assessment data to infer a learner's instructional proficiency relative to standardized curriculum benchmarks and dynamically adapts instructional content delivery based on the inferred proficiency. Adaptation may include modifying content difficulty, sequencing instructional pathways, unlocking or restricting instructional materials, or altering gameplay-based instructional experiences.

In one or more embodiments, the system maintains a learner profile that stores inferred instructional proficiency, assessment history, and progression data, as well as psychometric data associated with the learner. Psychometric data may include, by way of example and not limitation, gameplay preferences, subject matter preferences, interaction styles, motivation indicators, or personality-related attributes. The system utilizes the learner profile to inform adaptive instructional content delivery, including selection, presentation, pacing, or sequencing of instructional materials, while maintaining alignment with standardized academic curriculum requirements.

By integrating instructional delivery, assessment, and adaptive content selection within a unified game-based system, the disclosed invention enables continuous evaluation of learner proficiency while preserving instructional flow and supporting personalized progression through standardized academic curriculum.

In one or more embodiments, the system may be provided online or as a virtual/edu-metaverse environment.

In one or more embodiments, the virtual environment is provided as an adaptive AI-driven interactive educational platform. This may be provided as an MMORPG or non-MMORPG-type game.

In one or more embodiments, the virtual environment can be engaged with using a computing device, including a desktop computer, laptop computer, tablet, gaming console, smart device, virtual/augmented reality interface(s), etc.

In one or more embodiments, the system includes an AI engine to analyze, in real time, the users'interactions during gameplay. The AI engine dynamically updates user tasks, quests, and instructional content based on assessment-derived indicators of instructional proficiency and learner interaction data, thereby adapting instructional delivery while maintaining alignment with standardized academic curriculum.

### BRIEF DESCRIPTION OF THE DRAWINGS

A complete understanding of the present embodiments and the advantages and features thereof will be more readily understood by reference to the following detailed description when considered in conjunction with the accompanying drawings, wherein:

FIG. 1 illustrates a block diagram of an example computing system infrastructure (computer system 100) for implementing an adaptive digital game-based learning platform, including a processor, memory, data storage, input/output devices, one or more interfaces, and network connectivity to one or more user computing devices, administrator computing devices, and third-party computing devices;

FIG. 2 illustrates a block diagram of an example application program (application program 200) of the computing system, including functional modules such as a communication module, a database engine, a psychometric data module, a user module, a gameplay module, a display module, an AI engine, and an assessment module; and

FIG. 3 illustrates a flowchart of example user and gameplay flows implemented by the system, including user access and onboarding, collection of assessment data from gameplay interactions and instructional assessments, learner profile updating, adaptive instructional content delivery within the game-based environment, and progress tracking.

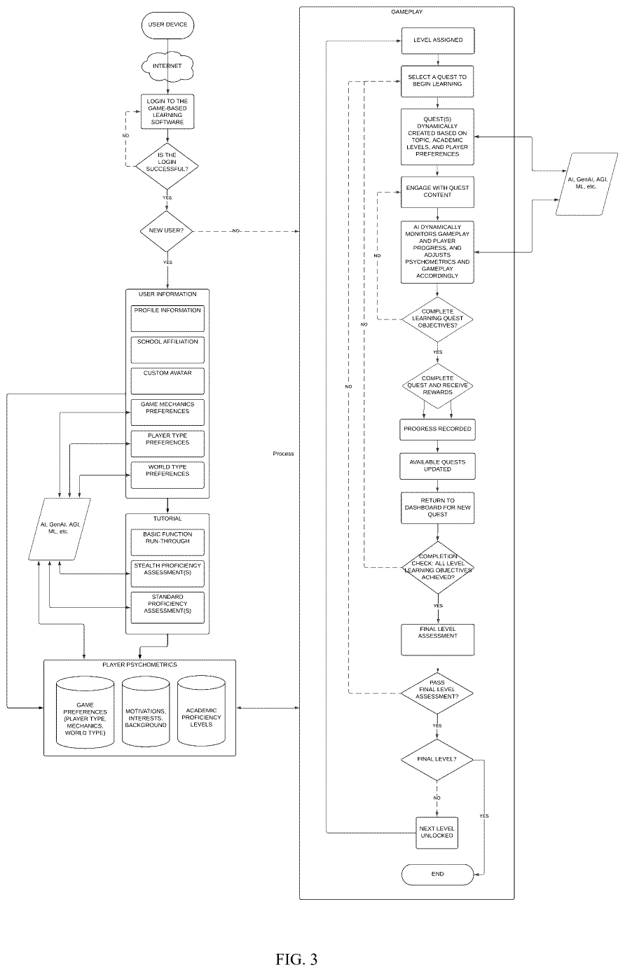

### DETAILED DESCRIPTION

### 1. System Architecture Overview

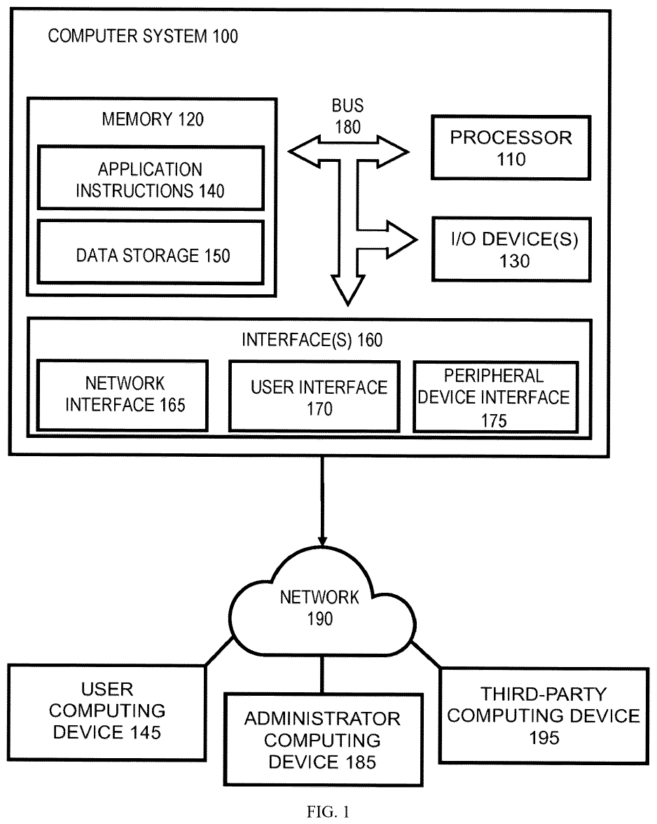

In one or more embodiments, the disclosed adaptive educational system is implemented as a computer-implemented platform comprising a computing system 100, as illustrated in FIG. 1. The computing system 100 includes one or more processors 110 coupled to one or more memory devices 120 via a system bus 180. The memory devices 120 store instructions that, when executed by the one or more processors 110, cause the system to perform the functions described herein.

The computing system 100 may further include one or more input/output devices 130, data storage devices 140, and one or more interfaces 160 enabling communication with external systems and networks 190. The computing system 100 may communicate with one or more user computing devices 170, administrator computing devices 172, and third-party computing devices 174 through the network 190.

User computing devices 170 may include, by way of example and not limitation, desktop computers, laptop computers, tablet devices, gaming consoles, smart devices, and virtual or augmented reality interfaces. Communication between system components may occur over wired or wireless connections, public networks, private networks, or combinations thereof.

The system architecture supports storage and management of learner data, including learner profiles, assessment data, psychometric data, and instructional content. In some embodiments, system components may be distributed across multiple physical or virtual computing environments, including cloud-based infrastructures. In other embodiments, portions of the system may be implemented locally on a user computing device or within a hybrid architecture.

This system architecture enables scalable delivery of instructional content, collection of assessment data, and adaptive instructional processing in real time or near real time.

### 2. Interactive Game-Based Environment

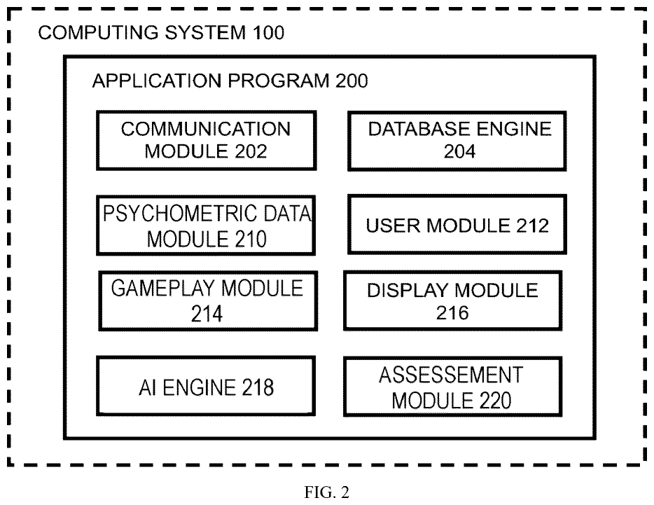

In one or more embodiments, the system executes an application program 200, as illustrated in FIG. 2, to present an interactive game-based learning environment through which instructional content aligned with one or more standardized academic curricula is delivered to learners. The application program 200 may be hosted on the computing system 100 and executed by the one or more processors 110.

The application program 200 may include a communication module 202 configured to manage data exchange between system components and user computing devices, and a database engine 204 configured to store and retrieve learner profiles, assessment data, psychometric data, and instructional content. The application program 200 may further include a psychometric data module 210, a user module 212, a gameplay module 214, a display module 216, an artificial intelligence engine 218, and an assessment module 220.

The gameplay module 214 enables presentation of an interactive game-based environment in which learners engage with instructional content through gameplay mechanics, tasks, simulations, quests, or other interactive activities. The display module 216 may generate visual, auditory, or multimodal interfaces through which the interactive environment is presented to the learner.

Instructional content may be embedded directly within gameplay elements such that engagement with the interactive environment inherently involves interaction with educational material. In some embodiments, instructional content is presented through in-game tasks, challenges, narratives, simulations, or virtual scenarios corresponding to academic subject matter. In other embodiments, instructional content may be presented alongside gameplay through integrated instructional interfaces.

The interactive game-based environment may be implemented in a variety of formats, including but not limited to a massively multiplayer online role-playing game (MMORPG), a single-player or cooperative game environment, an immersive simulation, or a non-MMORPG interactive digital learning environment. The system does not require instructional content to be delivered exclusively through any particular game genre, narrative structure, or visual style.

Rather, the interactive game-based environment functions as a flexible delivery mechanism through which instructional content and assessments may be presented in a manner that supports adaptive instructional delivery aligned with standardized academic curriculum requirements.

### 3. Assessment Generation and Collection

In one or more embodiments, the system is configured to collect assessment data associated with learner interaction with the interactive game-based environment. Assessment data may be generated from both explicit instructional assessments and gameplay-based interactions.

Explicit instructional assessments may include, by way of example and not limitation, placement assessments, quizzes, tests, mastery checkpoints, or other evaluative instruments designed to assess learner understanding of instructional content. Such assessments may be presented within the interactive game-based environment or through integrated assessment interfaces.

Gameplay-based assessment data may be derived from learner interactions occurring during gameplay. Such interactions may include task completion metrics, decision-making patterns, response timing, error frequency, navigation behavior, interaction sequences, or other in-game behaviors that implicitly reflect instructional proficiency. These gameplay-based interactions function as stealth assessment mechanisms that allow the system to evaluate learner proficiency without interrupting instructional flow.

In some embodiments, assessment data is collected continuously as the learner engages with the interactive environment. In other embodiments, assessment data may be collected at discrete intervals or in response to specific instructional events. The collected assessment data is stored and made available for subsequent analysis to infer instructional proficiency and inform adaptive instructional content delivery.

### 4. Instructional Proficiency Inference

In one or more embodiments, the system analyzes collected assessment data to infer an instructional proficiency level of a learner relative to one or more standardized academic standards. Assessment data used for proficiency inference may include data derived from explicit instructional assessments, gameplay-based interactions, or a combination thereof.

The system processes assessment data to evaluate learner performance across instructional objectives associated with one or more academic subjects. In some embodiments, assessment data is mapped to curriculum-aligned benchmarks corresponding to instructional grade levels, skill bands, or competency thresholds. The inferred instructional proficiency level may reflect a learner's current placement, progression status, or mastery level within a standardized curriculum framework.

Inference of instructional proficiency may occur continuously as assessment data is collected during learner interaction with the interactive game-based environment. In other embodiments, proficiency inference may occur periodically or in response to completion of specific instructional activities, assessments, or gameplay events. The system may update inferred instructional proficiency levels incrementally based on newly collected assessment data.

The instructional proficiency inference process is independent of any specific assessment format, gameplay mechanic, or instructional presentation style. Rather, the system evaluates learner performance indicators to determine instructional proficiency in a manner that supports adaptive instructional delivery across diverse learning modalities.

In some embodiments, the inferred instructional proficiency level is stored within a learner profile and used as an input for adaptive instructional content selection and sequencing. The system may further generate one or more indicators of learner progress corresponding to the inferred instructional proficiency level, enabling real-time or near real-time visibility into learner advancement across academic subjects.

### 5. Learner Profile and Psychometric Data

In one or more embodiments, the system maintains a learner profile associated with each learner. The learner profile stores data used by the system to support instructional assessment, proficiency inference, and adaptive instructional content delivery. The learner profile may be stored in one or more data repositories accessible to the system architecture described herein.

The learner profile may include assessment data, inferred instructional proficiency levels, assessment history, progression data, and psychometric data associated with the learner. As used herein, psychometric data broadly refers to data characterizing learner attributes, behaviors, and performance relevant to instructional delivery and assessment.

Psychometric data may include, by way of example and not limitation, gameplay preferences, subject matter preferences, interaction styles, motivation indicators, personality-related attributes, assessment results, test scores, demonstrated content mastery, learning progression metrics, rates of instructional improvement, error patterns, and other indicators of instructional proficiency or learning performance.

In some embodiments, psychometric data is derived from learner interaction with the interactive game-based environment, including gameplay behaviors, task engagement patterns, and assessment outcomes. In other embodiments, psychometric data may be derived from explicit instructional assessments or historical learner performance records. Psychometric data may be dynamically updated as the learner engages with instructional content and assessments.

The system utilizes the learner profile, including psychometric data and inferred instructional proficiency levels, to inform adaptive instructional content delivery. Psychometric data may be used to modify presentation, pacing, sequencing, or modality of instructional content while maintaining alignment with standardized academic curriculum requirements. Instructional objectives and curriculum scope are determined based on inferred instructional proficiency and applicable academic standards, independent of psychometric data.

By maintaining and updating learner profiles that integrate assessment data, inferred instructional proficiency, and psychometric data, the system supports personalized instructional delivery while preserving standardized academic alignment and continuous evaluation of learner progress.

### 6. Adaptive Instructional Content Delivery

In one or more embodiments, the system adapts instructional content delivery within the interactive game-based environment based on the inferred instructional proficiency level of the learner. Adaptive instructional content delivery may include modifying content difficulty, pacing, sequencing, modality, or instructional pathways to align with the learner's inferred proficiency relative to standardized academic curriculum requirements.

Instructional content adaptation is driven primarily by assessment-derived indicators of instructional proficiency. The system utilizes inferred instructional proficiency levels to determine appropriate instructional objectives, content scope, and progression through curriculum-aligned material. Adaptation of instructional content delivery ensures that learners are presented with instructional material appropriate to their current level of mastery while supporting advancement toward curriculum-defined learning outcomes.

In some embodiments, psychometric data associated with the learner is utilized to inform how instructional content is presented, without altering instructional objectives or curriculum scope. Psychometric data may influence presentation style, interaction modality, pacing, or sequencing of instructional content to support effective learning experiences while maintaining alignment with standardized academic standards. Instructional objectives, assessment criteria, and curriculum alignment remain independent of psychometric data.

Adaptive instructional content delivery may be implemented through a variety of mechanisms within the interactive game-based environment. Such mechanisms may include dynamically selecting instructional tasks or challenges, adjusting instructional pathways or progression routes, unlocking or restricting instructional materials, or modifying gameplay-based instructional experiences in response to inferred instructional proficiency.

In some embodiments, adaptive instructional content delivery occurs in real time or near real time as assessment data is collected and analyzed. In other embodiments, adaptation may occur at discrete intervals, such as following completion of an instructional module, assessment event, or gameplay milestone. The system may support continuous refinement of instructional delivery as learner proficiency evolves over time.

By adapting instructional content delivery based on inferred instructional proficiency while maintaining standardized academic alignment, the system enables personalized instructional progression without sacrificing instructional rigor or assessment integrity.

### 7. AI Engine (Implementation-Agnostic)

In one or more embodiments, the system includes an artificial intelligence (AI) engine configured to analyze assessment data, learner interaction data, and learner profile information to support instructional proficiency inference and adaptive instructional content delivery. The AI engine operates as a computational component of the system architecture and may be implemented using one or more algorithmic approaches.

The AI engine may process assessment data derived from explicit instructional assessments, gameplay-based interactions, or a combination thereof. The AI engine may further utilize learner profile data, including inferred instructional proficiency levels and psychometric data, as inputs for adaptive instructional decision-making. The AI engine may evaluate relationships among assessment outcomes, learner behaviors, and instructional performance indicators to inform adaptation of instructional content delivery.

In some embodiments, the AI engine employs rule-based logic, statistical models, machine learning models, or hybrid approaches to analyze input data and generate outputs. The specific algorithms, model architectures, training methodologies, or parameterizations used by the AI engine are not limited by the present disclosure and may vary depending on implementation requirements.

The AI engine may operate in real time or near real time to support continuous analysis of learner interaction and assessment data. In other embodiments, the AI engine may operate asynchronously or at defined intervals. The AI engine may update inferred instructional proficiency levels, psychometric data, or instructional adaptation parameters based on newly collected data.

In one or more embodiments, the AI engine may generate or modify narrative content, storyline elements, or gameplay experiences within the interactive game-based environment. Any such narrative or gameplay generation is constrained by instructional objectives and standardized academic curriculum requirements and is configured to support learner understanding of instructional content. Narrative generation, where employed, functions as a mechanism for instructional delivery rather than as an independent entertainment objective. The AI engine supports instructional assessment and adaptive instructional content delivery in accordance with standardized academic curriculum requirements, regardless of whether narrative elements are utilized.

In some embodiments, the AI engine may be implemented as a centralized service accessible to multiple user computing devices. In other embodiments, portions of the AI engine may be distributed across system components or executed locally on a user computing device. The AI engine may be integrated with the system architecture described herein to support scalable, adaptive educational experiences.

### 8. Optional Embodiments

In some embodiments, the interactive game-based environment supports multiplayer or cooperative learning experiences. Multiple learners may interact within a shared virtual environment, collaborate on instructional tasks, or engage in group-based challenges aligned with standardized academic curriculum objectives. The system may track individual learner performance within multiplayer activities and update learner profiles independently based on assessment-derived indicators of instructional proficiency.

In some embodiments, the interactive game-based environment includes non-player characters (NPCs) configured to provide instructional guidance, feedback, or assessment prompts. NPCs may present instructional content, facilitate practice activities, or respond to learner interactions based on inferred instructional proficiency levels. NPC behavior and instructional interactions may be dynamically adapted to support learner progression through curriculum-aligned material.

In some embodiments, the system incorporates real-world instructional tasks or activities that complement in-game learning. Learners may complete real-world tasks corresponding to instructional objectives and submit evidence of task completion through the interactive game-based environment. The system may verify real-world task completion manually or automatically and incorporate associated assessment data into instructional proficiency inference and learner profile updates.

In some embodiments, the interactive game-based environment supports immersive or extended reality interfaces, including virtual reality (VR), augmented reality (AR), or mixed reality (MR) interfaces. Instructional content and assessments may be delivered through immersive simulations or virtual scenarios aligned with standardized academic curriculum objectives. Learner interactions within immersive environments may generate assessment data used for instructional proficiency inference.

In some embodiments, the system supports accessibility features and alternative interaction modalities to accommodate diverse learner needs. Such features may include adaptive interfaces, alternative input methods, assistive technologies, or configurable presentation modes. Accessibility adaptations may be implemented while maintaining alignment with standardized academic curriculum requirements and instructional assessment integrity.

In some embodiments, narrative progression within the interactive game-based environment is mapped to instructional milestones or curriculum-aligned objectives. Advancement through narrative elements may correspond to demonstrated instructional proficiency or completion of instructional activities. Narrative content, where utilized, functions as a vehicle for instructional delivery and reinforcement of academic concepts rather than as an independent entertainment objective.

In some embodiments, the system supports cross-platform access and continuity of learner progress across multiple user computing devices. Learners may access the interactive game-based environment using different devices while maintaining persistent learner profiles, assessment data, and instructional progression.

1. A computer-implemented adaptive educational system, comprising:
one or more processors;
one or more memory devices storing instructions that, when executed by one or more processors, cause the system to:
maintain a learner profile associated with a learner, the learner profile including instructional proficiency data and assessment history;
present an interactive game-based environment configured to deliver instructional content aligned with one or more standardized academic curricula;
collect assessment data associated with the learner during interaction with the interactive game-based environment, wherein the assessment data includes data derived from gameplay-based interactions and data derived from explicit instructional assessments;
analyze the assessment data to infer an instructional proficiency level of the learner relative to one or more academic standards;
update the learner profile based on the inferred instructional proficiency level; and
adapt instructional content delivery within the interactive game-based environment based on the inferred instructional proficiency level,
wherein the system is configured to provide an indication of learner progress corresponding to the inferred instructional proficiency level.

2. The system of claim 1, wherein the learner profile further includes psychometric data associated with the learner.

3. The system of claim 2, wherein the psychometric data includes one or more of gameplay preferences, subject matter preferences, interaction styles, motivation indicators, or personality-related attributes.

4. The system of claim 2, wherein the system utilizes the psychometric data to modify presentation, pacing, or sequencing of instructional content while maintaining alignment with standardized academic curriculum requirements.

5. The system of claim 2, wherein the system weights psychometric data relative to assessment data when adapting instructional content delivery.

6. The system of claim 2, wherein the psychometric data is dynamically updated based on ongoing interaction with the interactive game-based environment.

7. The system of claim 2, wherein the psychometric data is updated based on learner performance on explicit instructional assessments.

8. The system of claim 2, wherein the psychometric data further includes one or more learning performance metrics selected from assessment results, test scores, demonstrated content mastery, learning progression indicators, or rates of instructional improvement.

9. A computer-implemented method for adaptive instructional delivery within an interactive
game-based learning environment, the method comprising:
presenting, by one or more processors, an interactive game-based environment configured to deliver instructional content aligned with one or more standardized academic curricula;
collecting assessment data associated with a learner during interaction with the interactive game-based environment, wherein the assessment data includes data derived from gameplay-based interactions and data derived from explicit instructional assessments;
analyzing the assessment data to infer an instructional proficiency level of the learner relative to one or more academic standards;
updating a learner profile to reflect the inferred instructional proficiency level;
adapting instructional content delivery within the interactive game-based environment based on the inferred instructional proficiency level; and
providing an indication of learner progress corresponding to the inferred instructional proficiency level.

10. The method of claim 9, further comprising maintaining psychometric data associated with the learner.

11. The method of claim 10, wherein the psychometric data includes one or more gameplay preferences, subject matter preferences, interaction styles, motivation indicators, or personality-related attributes.

12. The method of claim 10, wherein the psychometric data includes one or more learning performance metrics selected from assessment results, test scores, demonstrated content mastery, learning progression indicators, or rates of instructional improvement.

13. The method of claim 10, further comprising utilizing the psychometric data to modify presentation, pacing, or sequencing of instructional content while maintaining alignment with standardized academic curriculum requirements.

14. The method of claim 10, further comprising dynamically updating the psychometric data based on ongoing interaction with the interactive game-based environment.
